(19) United States
(12) Patent Application Publication
(10) Pub. No.: US 2006/0190461 A1
(43) Pub. Date: Aug. 24, 2006

(54) Apparatus, system, and method for managing objects in a database according to a dynamic predicate representation of an explicit relationship between objects

(76) Inventor: Brian Morris Schaefer, Foster City, CA (US)

Correspondence Address: KUNZLER & ASSOCIATES, 8 EAST BROADWAY, SUITE 600, SALT LAKE CITY, UT, 84111, US

(21) Appl. No.: 11/061,786

(22) Filed: Feb. 18, 2005

(51) Int. Cl. G06F 7/00

(52) U.S. Cl. 707/100

(57) ABSTRACT

An apparatus, system, and method are disclosed for managing objects in a database according to a dynamic predicate representation of an explicit relationship between objects. The apparatus includes a correlation module, a storage module, a query module, and a deletion module. The correlation module associates a set of predicate identifiers with a set of predicates. Each predicate is a description of a relationship between objects, or properties of objects. The predicate includes a predetermined number of arguments. The storage module stores a set of tuples in a database. Each tuple includes one of the predicate identifiers and the predetermined number of arguments as required by the predicate associated with the predicate identifier. The query module retrieves a subset of the tuples satisfying a query expression from the database. The deletion module deletes at least one of the tuples from the database.

### BACKGROUND OF THE INVENTION

1. Field of the Invention

This invention relates to databases and more particularly relates to managing objects in a database according to a dynamic predicate representation of an explicit relationship between objects.

2. Description of the Related Art

Databases are widely used in computer systems to provide an efficient way to store and access large amounts of information. Conventional databases typically store large amounts of information arranged in a consistent format.

Some of the most popular database types are the Relational, Hierarchical, Network, Object Oriented, and Logic Programming Datalog databases. Relational database are the most widely used and commercially successful databases. Relational databases store information according to relations, which a user may view as a set of tables comprising named columns.

FIG. 1 is a chart 100 illustrating the contents of a conventional relational database table. A relational database table is also called a relation. Each entry in the table is a tuple 102. A tuple 102 is an ordered combination of a predetermined number of arguments 104. Each of the arguments 104 of the tuple 102 can be a different data type. The data type used within a column of the table is the domain of the column. The domain of the column may be restricted in several ways. For example, one column of the table can comprise text arguments and another column of the table can comprise numerical arguments. In the depicted table, each entry is a tuple 102 comprising four arguments 106,108,110,112. For example, one tuple 114 comprises the arguments 104 “Jim,” “Jane,” “123-555-1234,” and “Seattle.”

Each argument 104 represents an object. An object is conventionally any person, place, thing, or idea typically represented as a noun. For example the argument “Jim” represents a person. The argument “123-555-1234” represents a phone number. The argument “Seattle” represents a place. The person, phone number, and place are each objects.

Conventionally, the arguments 104 of a tuple 102 represent objects that satisfy a relationship. For example, one relationship describing the arguments 104 of the tuples 102 illustrated in FIG. 1 is: “NAME is supervised by MANAGER. NAMES's phone number is PHONE. NAME works in the CITY office” where words in all capital letters are variables. The relationship stated above may be useful to a human resource department of a company. The relationship provides meaning to the tuples 102 stored in the database. Knowledge of the relationship could enable a database administrator to create a company directory using the tuples 102 of the database.

Conventionally, the database does not explicitly store the relationship together with the tuple 102. Rather, the names 116 of the columns of a tuple 102 implicitly represent the relationship. The relationship may be determined by examining the internal structure of the records and tables of the database. The internal structure of the records as tables is known as the database schema. Even after doing so, the table names and column names 116 may not clearly define the explicit relationships between the objects represented by the tuple arguments 104.

A database administrator manages tuples 102 in a database by performing various management operations. The management operations may include adding new tuples 102 to the database, deleting tuples 102 from the database, modifying the value of one or more arguments of a tuple 102, querying the database to retrieve one or more tuples 102, and other operations well known to those of skill in the art.

A limitation of implicit relationships is that a database user who does not have knowledge of the relationship can infer an incorrect relationship from the tuples 102 of the database. For example, the database administrator may infer that the table illustrated in FIG. 1 contains emergency contact information for employees and that the relationship between the arguments 104 of the tuples 102 of FIG. 1 is: “NAME's emergency contact is MANAGER. MANAGER's phone number is PHONE. NAME lives in CITY.” This problem of implying an incorrect relationship from a set of tuples 102 could be eliminated if an explicit relationship was stored in the database along with the arguments 104.

From the foregoing discussion, it is apparent that a need exists for an apparatus, system, and method for managing objects in a database that is in accordance with an explicit method for conveying the semantic content of the data and relationships. Beneficially, such an apparatus, system, and method would eliminate the possibility of incorrectly implying the relationship of data in a relation.

There are also applications, such as knowledge bases, artificial intelligence, and natural language processing, where the potential complexity of the semantic meaning of data requires a more complex data model. The system, method, and apparatus described herein may also be used to augment the semantic interpretation of data in conjunction with other database models.

### SUMMARY OF THE INVENTION

The present invention has been developed in response to the present state of the art, and in particular, in response to the problems and needs in the art that have not yet been fully solved by currently available databases. Accordingly, the present invention has been developed to provide an apparatus, system, and method for managing objects in a database according to a dynamic predicate representation of an explicit relationship between the objects that overcome many or all of the above-discussed shortcomings in the art.

The apparatus to manage objects in a database according to a dynamic predicate representation of an explicit relationship between the objects is provided with a logic unit containing a plurality of modules configured to functionally execute the necessary steps of managing the database. These modules in the described embodiments include a correlation module, a storage module, a query module, and a deletion module.

The correlation module associates a set of predicate identifiers with a set of predicates in a predicate table. Each predicate is a description of a relationship between objects. The predicate includes a predetermined number of arguments. The storage module stores a set of tuples in a database. Each tuple includes one of the predicate identifiers and the predetermined number of arguments as required by the predicate.

The query module retrieves a subset of the tuples satisfying a query expression from the database. The query expression includes zero or more of the arguments. Preferably, the query expression combines arguments for a plurality of predicates in a single query. The deletion module deletes at least one of the tuples from the database.

In one embodiment, the apparatus includes a conversion module. The conversion module maps the arguments of a first tuple satisfying a first predicate to a second tuple satisfying a second predicate.

A system of the present invention is also presented for translating a first relationship between objects represented by a first predicate to a second relationship between the objects represented by a second predicate. In particular, the system, in one embodiment, includes a first database, a second database, and a translation module.

The first database stores a first set of tuples according to a first predicate. The first predicate describes a relationship between one or more objects. Each tuple stored in the first database includes a first predetermined number of arguments. The second database stores a second set of tuples according to a second predicate. The second predicate describes a relationship between one or more objects. Each tuple stored in the second database includes a second predetermined number of arguments. Preferably, each of the tuples contained in the second set of tuples includes a predicate identifier.

The translation module includes a query module, a mapping module, and a storage module. The query module retrieves a first tuple from the first database. The mapping module maps one or more of the arguments of the first tuple satisfying the first predicate to one or more of the arguments of a second tuple satisfying the second predicate. The storage module stores the second tuple.

In one embodiment, the system includes an association module. The association module associates the first predicate with the first database and the second predicate with the second database. Preferably, the association module stores a first association between the first predicate and a first predicate identifier and a second association between a second predicate and a second predicate identifier in a table.

A method is also presented for managing objects in a database according to a dynamic predicate representation of an explicit relationship between the objects. The method in the disclosed embodiments substantially includes the steps necessary to carry out the functions presented above with respect to the operation of the described apparatus and system. In one embodiment, the method includes an operation to associate a set of predicate identifiers with a set of predicates, an operation to store a set of tuples in a database, and an operation to retrieve a subset of the tuples from the database.

Each predicate managed by the method describes a relationship between objects using a predetermined number of arguments. Each tuple includes one of the predicate identifiers and the predetermined number of arguments required by the predicate associated with the predicate identifier. The operation to retrieve a subset of the tuples from the database utilizes a query expression that may include zero or more of the arguments. Preferably, the query expression combines arguments from a plurality of predicates.

In one embodiment, the method also includes an operation to delete at least one of the tuples from the database. In a further embodiment, the method includes an operation to map the arguments of a first tuple satisfying a first predicate to a second tuple satisfying a second predicate.

Preferably, the method includes an operation to modify one of the predicates and an operation to modify the predetermined number of arguments associated with one of the predicates. In one embodiment, the method also includes an operation to modify the predicate associated with at least one of the tuples. In a further embodiment, the method includes an operation to associate one of the arguments with a plurality of tuples and an operation to retrieve a group of tuples associated with a particular argument.

Preferably, the method also includes an operation to store the association between the set of predicate identifiers and the set of predicates in the database and an operation to retrieve a predicate associated with a predicate identifier and an operation to retrieve a group of predicates associated with a particular argument. Preferably, the method includes an operation to modify a value for at least one of the arguments associated with at least one of the tuples.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a chart illustrating the contents of an example table in a conventional relational database;

FIG. 2A is a chart illustrating the contents of a relational database table;

FIG. 2B is a chart illustrating the contents of a database table;

FIG. 2C is a chart illustrating the contents of a database table;

FIG. 2D is a chart illustrating the contents of a database table;

FIG. 3A is a chart illustrating a mapping between predicate identifiers and predicates;

FIG. 3B is a chart illustrating a mapping between variable names and domains;

FIG. 3C is a chart illustrating a mapping between domains and data types;

FIG. 3D is a chart illustrating the contents of a database;

FIG. 4 is a schematic block diagram illustrating one embodiment of an apparatus for managing objects in a database according to a dynamic predicate representation of an explicit relationship between objects;

FIG. 5A is a chart illustrating a mapping between predicate identifiers and predicates;

FIG. 5B is a chart illustrating the contents of a dynamic predicate relation;

FIG. 6 is a schematic block diagram illustrating one embodiment of a system for managing objects in a database according to a dynamic predicate representation of an explicit relationship between objects;

FIG. 7A is a chart illustrating a mapping between predicate identifiers and predicates;

FIG. 7B is a chart illustrating the contents of a conventional relational database table;

FIG. 7C is a chart illustrating the contents of a dynamic predicate relation; and

FIG. 8 is a schematic flow chart diagram illustrating one embodiment of a method for managing objects in a database according to a dynamic predicate representation of an explicit relationship between objects.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of method on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

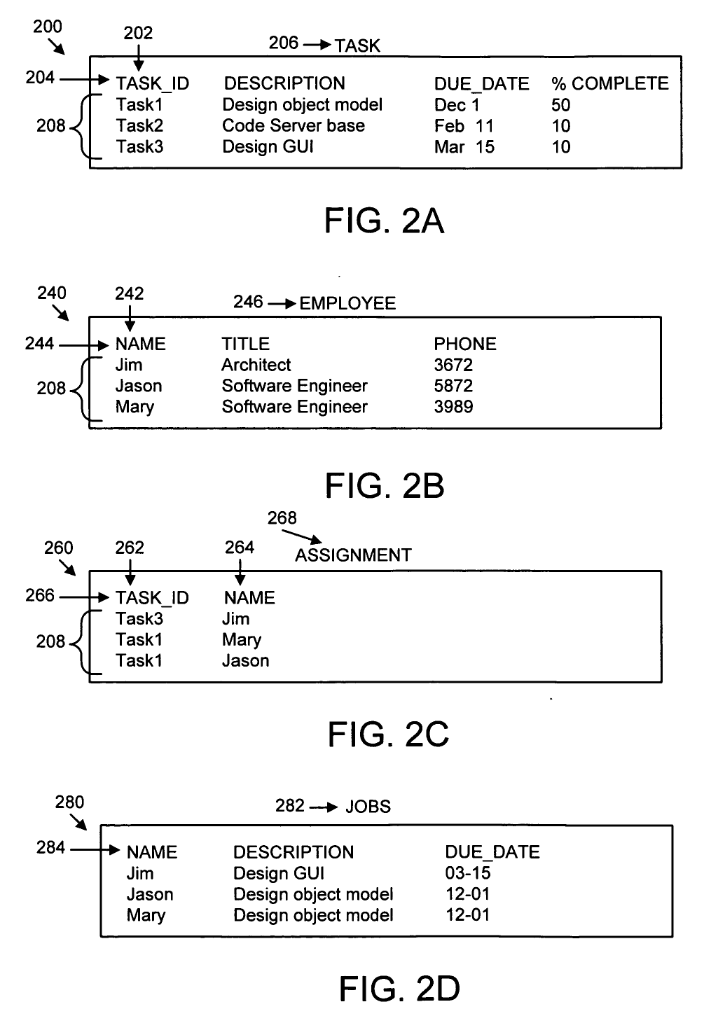

Foreign keys relate data elements in a first relational database table with data elements in other tables. FIGS. 2A-C depict a simple example illustrating the use of foreign keys. FIG. 2A illustrates a TASK table 200. FIG. 2B illustrates an EMPLOYEE table 240. FIG. 2C illustrates an ASSIGNMENT table 260. FIG. 2D illustrates a JOBS table 280. The column TASK_ID 262 in the ASSIGNMENT table 260 is a foreign key that refers to the TASK_ID column 202 in the task table 200. Furthermore, the column NAME 264 in the ASSIGNMENT table 260 is a foreign key referring to the column NAME 242 in the EMPLOYEE table 240.

As described above, the interpretation of the data in the tables 200, 240, 260, 280 of a relational database is implied by the table names 206, 246, 268, 282 by the column names 204, 244, 266, 284 by the constraints such as the foreign keys, by the domains, and in no other way. The names 206, 246, 268, 282 chosen for the tables 200, 240, 260, 280 and the names 204, 244, 266, 284 chosen for the columns are intended to convey semantic content for the user of the tables 200, 240, 260, 280. The user is expected to infer the meaning of the data from these names. In most cases this is a reasonable expectation.

For example, the task table 200 in FIG. 2A, could be reasonably interpreted as: “The task identified by Task1, described as ‘Design object model,’ is due to be completed by Dec. 1 and is currently 50% compete.” However, there are other reasonable interpretations as well. For example, the task table 200 could also be reasonably interpreted as: “The task identified by Task1, described as ‘Design object model’ must be 50% compete by the due date Dec. 1.”

The information contained in a table is determined by the particular set of tuples (rows) 208 in the relation (table). The set of tuples 208 may vary over time as new entries are added to a table or existing table entries are updated. This set of tuples 208 determines a group of objects that share a common relation with each other.

Since relations (tables) are sets of tuples 208, relations have defined set operations, such as union and intersection, that may be applied to the relations. However, the reliance in relational databases for meaning derived from column names 204, 244, 266, 284 imposes severe restrictions on the relations that can participate in these set operations. For set operations to be well defined in a relational database, the relations participating in the operation must have the same column names 204, 244, 266, 284 and domains (data types).

The problem of data meaning, increases significantly as operations of the relational calculus, such as projections or joins, are performed on the tables. For example, a join operation can be applied to the tables 200, 240, 260 in FIGS. 2A-C to produce the relation JOBS 280 illustrated in FIG. 2D. The data in this table 280 could be interpreted as meaning that Jason and Mary are each to deliver their own design for the object model by Dec. 1, or it could be interpreted as meaning that they are both to deliver one common design for the object model by that date.

In the task-assignment schema illustrated in FIGS. 2A-D, it may not be difficult to discern the proper interpretation of the data. However, most relational database schemas contain many more relations with many more columns. In addition, the complexity of the task-assignment problem illustrated in FIGS. 2A-D is not high, and mistakes in interpretation may not be critical. If the tables in FIGS. 2A-C were named “drug table,” “patient table,” and “treatment table” and were used to determine relationships in a medical trial, then the proper interpretation of the data may be critical. However, as described above, even in simple cases, meanings conveyed through column names can be interpreted in different ways.

The notion that relationships exist among real world objects and concepts arises from observations. For example, different objects may appear to interact and influence one another, the properties of objects may appear to be related to each other, some objects can be classified in hierarchies of subclasses, some objects can be viewed as parts of other objects, and certain effects appear to be caused by particular actions.

The discovery and recording of these relations are a source of human knowledge. The concepts of observing and recording relations may be described abstractly and modeled in mathematics through the use of sets.

A mathematical relation is a set of ordered tuples, usually denoted by an expression such as:
R={>x, y<:xεD₁,yεD₂,P(x, y)}
which is read: “The relation R consists of a set of ordered pairs <x, y> such that x belongs to the domain set D₁, y belongs to the domain set D₂, and <x , y> satisfies the predicate P(x, y).”

The predicate P(x, y) may be an equation, such as x²+y²=4, so that the relation would consist of all the points on a circle of radius 2. In general, a predicate is a mathematical statement that has a truth value. That is, P( ) is a function that maps ordered elements from a set of domains to the set {true, false}.

Because a mathematical relation is a set, operations such as union and intersection may be performed on relations to create more complex relations. The computational capabilities of electronic computers make possible the usefulness of an extended definition for a mathematical relation as follows:
R=U{<x, y, k>:xεD₁, yεD₂, kεI, Pₖ(x, y)}

In this case, each ordered tuple may have its own truth valued predicate, chosen from a set of predicates. The tuple may of course be of higher dimension. The dimension, or number of arguments in a tuple, is often referred to as the ‘arity’ of the tuple. The relation may contain tuples of different arity, so that we would write:
R=U{<x₁, x₂, . . . xₙₖ, k>:xᵢεDᵢ, kεI, Pₖ(x₁, x₂, . . . , xₙₖ)}

A predicate in mathematics is usually considered to be a truth valued function. In grammar and linguistics a predicate is a part of a sentence that describes the subject of the sentence. In other words, the predicate is what is said about the subject. In distinction, a predicate as used herein is any set of natural language sentences, with zero or more words replaced by variables.

An example of a predicate is: “Employee named x₁ is assigned to task x₂.” More descriptive terms may be used in place of variable names such as x₁ as a mnemonic aid. For example in the following predicate both NAME and TASK are variables: “Employee named NAME is assigned to task TASK.”

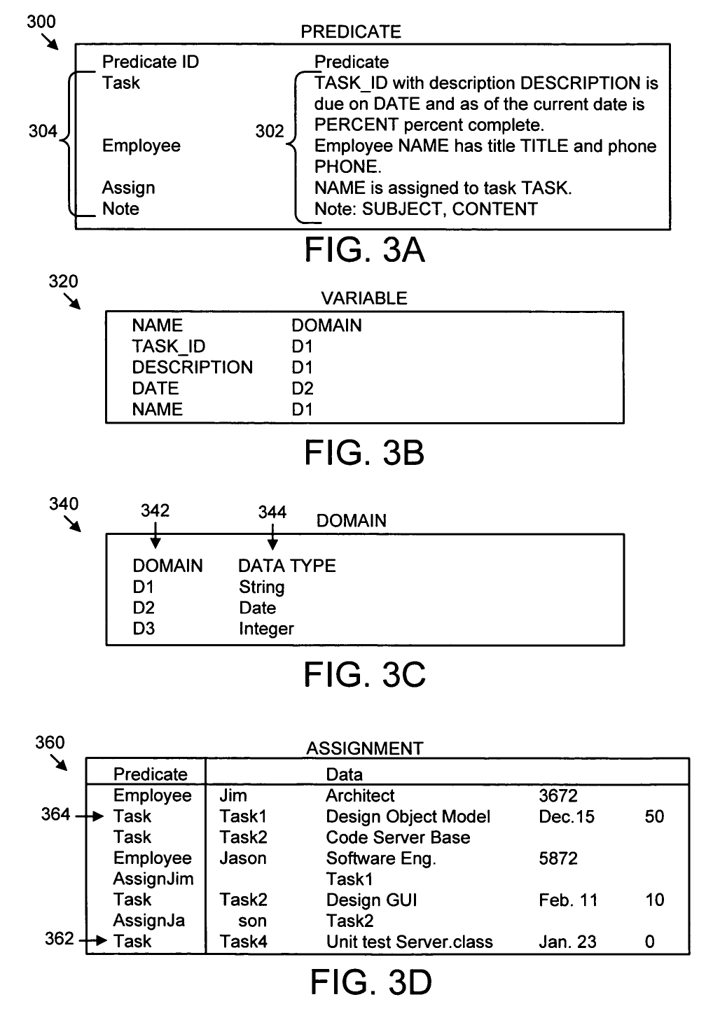

FIG. 3A is a chart 300 illustrating additional examples of predicates 302. Each predicate 302 is assigned to a predicate identifier 304. Each predicate comprises a sentence with zero or more variables. Variables are shown in all capital letters in the chart 300.

FIG. 3B is a chart 320 illustrating a mapping between variable names and domains. FIG. 3C is a chart 340 illustrating examples of variable domains 342. Each variable domain 342 is assigned a data type 344 such as string, integer, date, and the like. Each variable used in a predicate 302 is assigned a domain 342.

The conventional condition that the predicate 302 map the variables only to the set {true, false} is relaxed. This allows for flexibility to include modal logic such as “is possibly true,” “is necessarily true,” “is probably true depending on a condition,” and the like. Verbs within the predicate 302 may also be variables. For example in the predicate “The tool x₁ the component,” x₁, may belong to a domain comprising the set {“removes,” “fastens,” “pulls,” “destroys,” and the like}. Additionally, predicates 302 may be any form of a sentence such as a statement, question or command, Predicates are not limited to a single sentence. In the dynamic predicate data model, the ordering of the variables is important. Order may be derived from the position of the variable in the predicate 302, or from a subscript on the variable.

In certain embodiments of the invention, it is possible to use position:name pairs to define the variables. However, position:name pairs are not essential because of the explicit availability of the predicates signifying the meaning of the variables to the user.

In a dynamic predicate relation such as the present invention, the meaning of each tuple of data in the relation may be different, in the sense that each tuple may be governed by a different predicate 302. The predicates 302 themselves may also be updated. The meaning of a predicate 302 may be changed by the data, as in the case when one of the variables is a verb. This structure of a relation is similar to a natural language paragraph, in which different sentences are used to create meaning in combination.

Operations on dynamic predicate relations may be written similar to Structured Query Language (SQL) operations. Commands in operations are maintained as similar as possible to ANSI standard SQL to facilitate learning and interoperability, although there are certain unavoidable differences because of the structure of the data.

From a user's point of view, a relational database comprises a set of tables, and queries create result sets that can also be viewed as tables. In a dynamic predicate database, users view the relations as tables of rows with variable number of columns and a reference to an explicit predicate 302 for each row, as shown in FIG. 3D.

In a dynamic predicate database, closure of the results of a query is maintained so that a query returns a dynamic predicate relation. The relation that is returned may be printed as the relation illustrated in FIG. 3D or with the predicates filled in, as in the examples below. Examples of a SQL-like statements for the dynamic predicate database illustrated in FIG. 3D in accordance with the present invention are shown below. Words in all capital letters are query commands.

INSERT INTO RELATION assignment PREDICATE Task (Task4, ‘Unit test Server.class’, Jan. 23, 0)

As a result, a new tuple 362 is added to the assignment table 360.

SELECT FROM assignment PREDICATE Task WHERE Description CONTAINS ‘Design Object model.’

The above query returns the contents of a tuple 364: “Task1 with description Design Object model is due on Dec. 15 and as of the current date is 50 percent complete.” The following command,

SELECT FROM assignment PREDICATE Assign WHERE NAME =‘Jim’ returns “Jim is assigned to task Task1.”

Second-order logic queries may be also be performed in one embodiment of a dynamic predicate database, such as:

SELECT FROM assignment ALL PREDICATES THAT INVOLVE ‘Jim’ returns the dynamic predicate relations: “Employee Jim has title Software Engineer and phone 3672.” and “Jim is assigned to task Task1.”

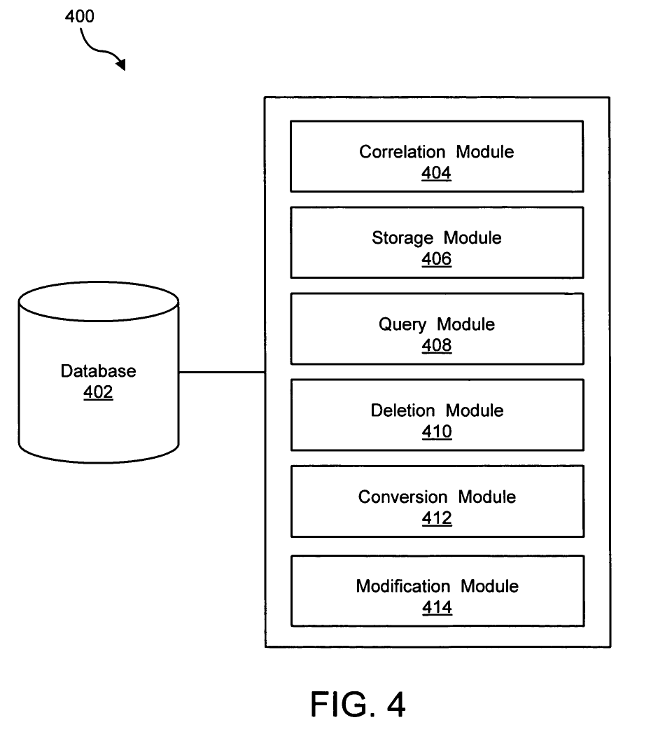

FIG. 4 illustrates an apparatus 400 for managing objects in a database 402 according to a dynamic predicate representation of an explicit relationship between objects. The apparatus 400 comprises a database 402, a correlation module 404, a storage module 406, a query module 408, and a deletion module 410. Optionally, the apparatus 400 may further comprise a conversion module 412 and a modification module 414. The database 402 stores information in a non-volatile manner. The database 402 may store information on a magnetic hard drive, flash memory, magnetic tapes, or other storage medium.

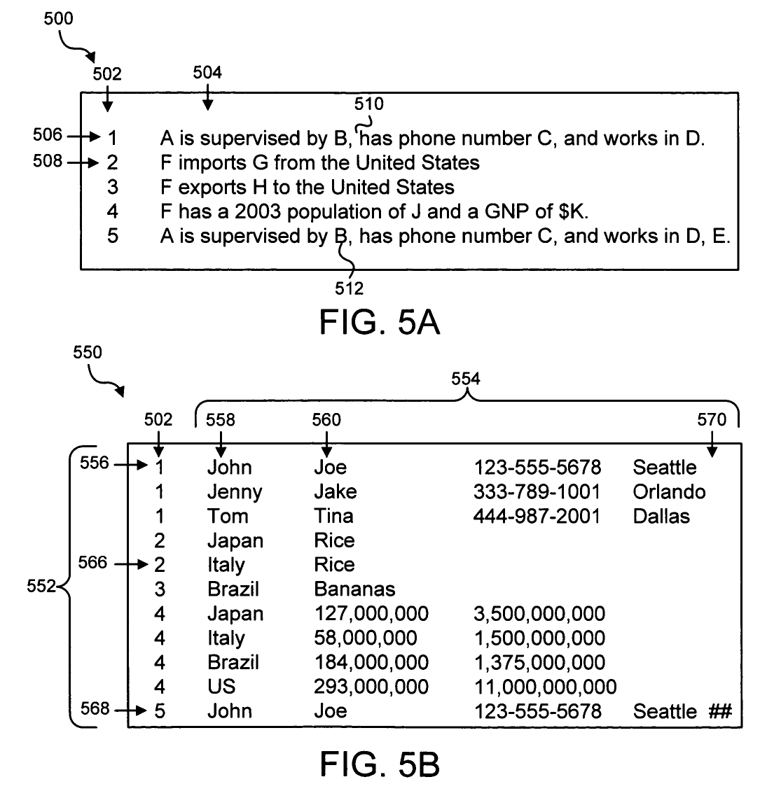

FIG. 5A is a chart 500 illustrating a predicate table. The predicate table stores an association between predicate identifiers 502 and predicates 504. The predicate identifier 502 may comprise a number or an alphanumeric label. Each predicate identifier 502 may be unique so that the correlation module 404 associates each predicate identifier 502 with a single predicate 504. The predicate identifier 502 provides an efficient, compact reference to a predicate 504.

A predicate is an explicit natural language expression of a relationship between one or more objects. The predicate may comprise a single sentence of text or symbols that represent the relationship. A compound predicate includes a plurality of predicates. Each predicate 504 explicitly describes a relationship between objects using a predetermined number of variables. For example, the predicate 510 of the first entry 506 of the chart 500 has four variables: “A,” “B,” “C,” and “D.” The predicate 504 of the second entry 508 of the chart 500 has two variables, “F” and “G.”

FIG. 5B illustrates the contents 550 of a dynamic predicate relation organized to use the chart of FIG. 5A to implement one embodiment of the present invention. The example relation comprises a plurality of tuples 552. A tuple 552 is created when the storage module 406 (See FIG. 4) stores the tuple 552 in the database 402. Each tuple 552 maybe stored as a record in the database 402. The set of tuples 552 may comprise a table in the database 402.

Each tuple 552 comprises one of the predicate identifiers 502 and the arguments 554 required by the predicate 504 associated with the predicate identifier 502. In certain embodiments, tuples 552 may be organized into different tables in a relational database, each table serving various database client needs. Each tuple 552 may comprise a different predicate identifier 502.

For example, the first tuple 556 in the database 402 comprises arguments 554 conforming to a first predicate 510 namely, “A is supervised by B, has phone number C, and works in D.” The first argument 558 of the tuple 552 corresponds with the variable “A” in the predicate 504. The second argument 560 of the tuple 552 corresponds with the variable “B” in the predicate 504, and so on.

In one embodiment, the arguments 554 may be stored in reverse order so that the first argument 558 of the tuple 552 corresponds with variable “D” in the predicate 504. The second argument 560 of the tuple 552 corresponds with the variable “C” in the predicate 504, and so on.

In a further embodiment, the arguments 554 may be stored with a variable identifier so that the arguments 554 may be in an arbitrary order within the tuple 552. For example, the arguments 554 of the tuple 552 maybe “B:Joe D:Seattle A:John C:123-555-5678.”

The fifth tuple 566 in the database 402 comprises arguments 554 conforming to the predicate 504 associated with predicate identifier 502 “2.” The fifth tuple 566 comprises two arguments 554 since the predicate 504 associated with predicate identifier 502 “2” requires two arguments 554: “F” and “G.” The number of arguments 554 in each of the tuples 552 of the database 402 depends on the predicate 504 on which the tuple 552 is based. Consequently, the entries in the database 402 may include a variable number of arguments 554.

The arguments 554 of a single tuple 552 maybe inserted into the predicate to form a complete natural language expression. For example, substituting the arguments 554 of a specific tuple 556 into the predicate 510 results in the following statement explicitly relating the arguments together: “John is supervised by Joe, has phone number 123-555-5678, and works in Seattle.” Similarly, the arguments 554 of each of the tuples 552 could be substituted for the variables in the predicates 504 corresponding to the tuples 552.

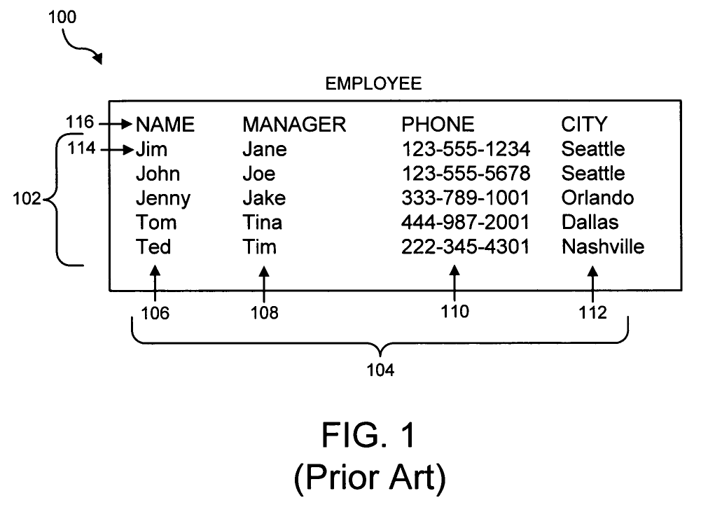

Conventional relational databases do not store predicates that explicitly relate the arguments 554 of the tuples 552 together along with the tuples 552. As mentioned above, explicit semantic relationships may be used in the original database design, but are not part of the schema and are not available to the end-users or database administrators. An administrator of a conventional database cannot be certain of the relationship between the arguments 554 of a tuple 552 without knowing the predicate 504 on which the tuple 552 is based. Without having access to an explicit predicate 504 the database administrator is susceptible to making a mistake in guessing the predicate, as was described above in relation to FIG. 1.

Returning now to FIG. 4, the correlation module 404 associates a set of predicate identifiers with a set of predicates and stores the association in a predicate table. The correlation module 404 may store the predicate table in a linked list, set of variables, table of a relational database, set of objects, or the like. The correlation module 404 enables a database administrator to create and store new predicates 504.

The storage module 406 creates new entries in the database 402. The storage module 406 may create tuples 552 in a conventional relational database by adding records comprising the tuple 552 to a conventional relational database table. Alternatively, the storage module 406 may store tuples 552 by creating a new record in a hierarchical, object-oriented, or other non-relational database. Preferably, the storage module 406 may create a plurality of tuples 552 that each use one or more of the same values for the arguments. If there are data that are common or repeated in the same relation, then a unique variable name addressing that data may be used. For example, in FIG. 5A both a first predicate 510 and a second predicate 512 use the same value for the variable named 554 “A.”

FIG. 5B depicts a plurality of tuples 552 using five different predicates 504 within a single table of a database. The tuples 552 may be stored in the database in alternative arrangements as well. For example, a different table may used to store all tuples 552 sharing the same predicate 504. Following this method, five tables would be required to store the tuples 552 depicted in FIG. 5B, one table for each of the unique predicates 504.

In certain embodiments, conventional database records may be adapted to include a predicate identifier 502. Consequently, the corresponding predicate 504 may include an argument for each column in the record. Alternatively, the predicate 504 may include null placeholders to account for irrelevant columns and still account for arguments defined for use within the predicate 504. In this manner, the present invention may be used to adapt conventional relational databases to include explicit predicates 504.

The query module 408 retrieves a subset of the tuples 552 from the database 402 satisfying a query expression. An example of a query expression is: “SELECT employees supervised by Jake.” The query module 408 examines each of the tuples 552 to determine which tuples 552 satisfy the query expression.

For efficiency, the query module 408 may determine which tuples 552 are based on a predicate 504 that could potentially satisfy the query expression. For example, the only query expression in the chart 500 depicted in FIG. 5A that involves a “population” is the predicate “F has a 2003 population of J and a GNP of $K.” with predicate identifier 502 “4.” The query module 408 may filter the tuples 552 that the query module 408 examines in determining which tuples 552 satisfy the query expression to tuples 552 based on predicate identifier 502 “4.” Of course, the query module 408 may use certain indexes (not shown) for further efficiency.

Preferably, the query expression combines arguments 554 for a plurality of predicates 504. “Select all countries importing rice from the United States with a population greater than 100,000,000.” is an example of a query expression containing arguments 554 from a plurality of predicates 504. The portion of the query expression relating to “importing rice” is based on the predicate 504 with predicate identifier 502 “2.” The portion relating to the population of a country is based in part on the predicate 504 with predicate identifier 502

The query module 408 performs comparisons between the query expression and tuples 552 stored in the database 402 using comparison and indexing techniques well known to those of skill in the art. The query module 408 may provide tuples 552 satisfying the query expression to a database user. The tuples 552 satisfying the query expression may be displayed to a database administrator, stored in a results file, printed on a printer, or otherwise provided to the database administrator.

Additionally, the query module 408 may retrieve a group of tuples 552 that include a particular argument value. For example, the query module 408 may retrieve all tuples 552 with arguments that have a value of “Japan.” Similarly, the query module 408 may retrieve a group of predicates 504 associated with a particular argument 554 rather than the argument value. The query module 408 may also retrieve a predicate 504 based on a database administrator supplied predicate identifier 502.

The deletion module 410 deletes at least one of the tuples 552 from the database 402. Based on a database administrator request, the deletion module 410 deletes the tuple 552 identified in the database administrator request from the database 402. The deletion module 410 may delete all tuples 552 satisfying a query expression. For example, the database administrator may request that tuples 552 satisfying the query expression “countries exporting bananas” be deleted from the database 402. The deletion module 410 uses techniques well known to those of skill in the art to identify the tuples 552 to be deleted and then delete them from the database 402. Additionally, the deletion module 410 may delete a predicate 504 from the predicate table, if it is not being used elsewhere.

In one embodiment, the apparatus 400 further comprises a conversion module 412. The conversion module 412 maps the arguments 554 of a first tuple satisfying a first predicate to a second tuple satisfying a second predicate. The database administrator may select a tuple 552 conforming with the first predicate to map to the second predicate. Next, the conversion module 412 retrieves the selected tuple 552 from the database 402 and creates a new tuple based on the second predicate.

The conversion module 412 then populates the new tuple with corresponding arguments 554 from the selected tuple. If the second predicate comprises additional arguments not present in the first predicate, database administrator supplied default values may be used for the additional arguments. Similarly, the second predicate may not include all of the arguments 554 of the first predicate. Finally, the conversion module 412 saves the new tuple in the database 402. Alternatively, the conversion module 412 saves the new tuple in a second database.

For example, the first predicate 510 (See FIG. 5A) may be “A is supervised by B, has phone number C, and works in D.” The second predicate 512 may be “A is supervised by B, has phone number C, and works in D, E.” The second predicate 512 has an additional argument “E” representing the state where “A” works. First, the conversion module 412 reads a selected tuple 556 based on the first predicate 510 from the database 402.

Next, the conversion module 412 creates a new tuple 568 based on the second predicate 512. The conversion module 412 populates arguments 554 “A,” “B,” “C,” and “D” of the new tuple 568 with the corresponding values from the selected tuple 556. The additional argument 570 “E” may be populated with the default value “##.”Alternatively, the state may be looked up in a table for the correct state if the city and telephone area code are known to be in that state. Of course the database administrator could select substantially any character or set of characters for the default value.

The conversion module 412 may perform additional mappings involving calculations. For example, two numerical arguments 554 in the first predicate 510 may be summed together to create a new argument used in the second predicate 512. Further mappings may comprise concatenating existing arguments 554 to create a plurality of new arguments, and other operations well known to those of skill in the art.

In another embodiment, the apparatus 400 further comprises a modification module 414. The modification module 414 enables a database user to modify the predicate identifiers 502, predicates 504, and tuples 552 stored in the database 402. A database user may modify one of the predicates 504 by changing the predetermined number of arguments 554 associated with a predicate 504. If the database user adds a new argument 554 to an existing predicate 504, the modification module 414 creates an additional argument 554 for existing tuples 552 associated with the predicate 504.

The modification module 414 populates the additional argument with a database administrator specified default value. Alternatively, the modification module 414 populates the additional argument with a value derived from the existing arguments 554 of the tuple 552. For example, the modification module 414 may populate the additional argument with a value parsed from one of the existing arguments 554.

The modification module 414 may also modify an existing predicate 504 by deleting one of the arguments 554 of the tuples 552 associated with the predicate 504. For example, the first predicate 510 depicted in FIG. 5A may be modified from “A is supervised by B, has phone number C, and works in D.” to “A is supervised by B and has phone number C.” The modified first predicate 510 has eliminated variable “D.” In this example, the modification module 414 would identify all tuples 552 based on the first predicate 510 and delete the argument 554 corresponding with variable “D” from the tuples 552.

Additionally, the modification module 414 may modify the existing predicate 504 without changing the number of arguments 554 associated with the predicate 504. The modification module 414 may also modify the value of one of the arguments 554 of a tuple 552. For example, the modification module 414 may change the value “John” in a selected tuple 556 to “Fred.”

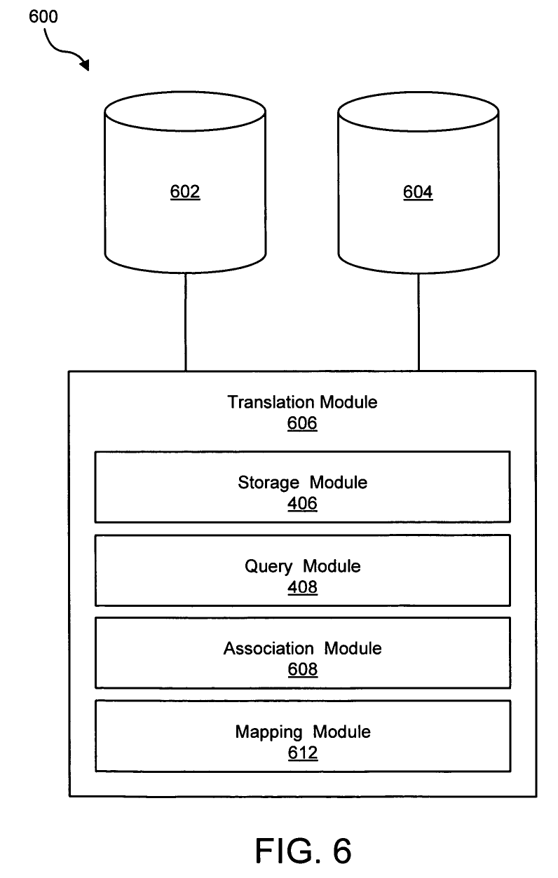

FIG. 6 illustrates a system 600 for translating a first tuple based on a first predicate to a second tuple based on a second predicate. The system 600 includes a first database 602, a second database 604, and a translation module 606.

The first database 602 stores a first set of tuples comprising values satisfying the first predicate. The first database 602 may be a conventional, relational database substantially the same as the database described above in relation to FIG. 1. The first database 602 may not store an explicit predicate identifier 502 as part of the tuples 552 stored in the first database 602. A database administrator may need to know the first predicate upon which the tuples 552 stored in the first database 602 are based since the first predicate is not explicitly stored in the first database 602.

The second database 604 stores a second set of tuples according to a second predicate. The second database 604 may be a conventional, relational database that does not store predicate identifiers 502. In this case, the database administrator needs to know the second predicate upon which tuples 552 stored in the second database 604 are based. This may have to be determined by reviewing design documentation for the database or a database schema. Alternatively, the second database 604 may explicitly store a predicate 504 as part of each tuple 552 stored in the second database 604.

The translation module 606 includes a storage module 406, a query module 408, an optional association module 608, and a mapping module 612. The storage module 406 and query module 408 operate in substantially the same manner as described above in relation to FIG. 4. The association module 608 creates an association table that associates a first predicate (the predicate that existing tuples 552 stored in the first database 602 are based on) with the first database 602 and a second predicate (the predicate that the translated tuples will be based on) with the second database 604.

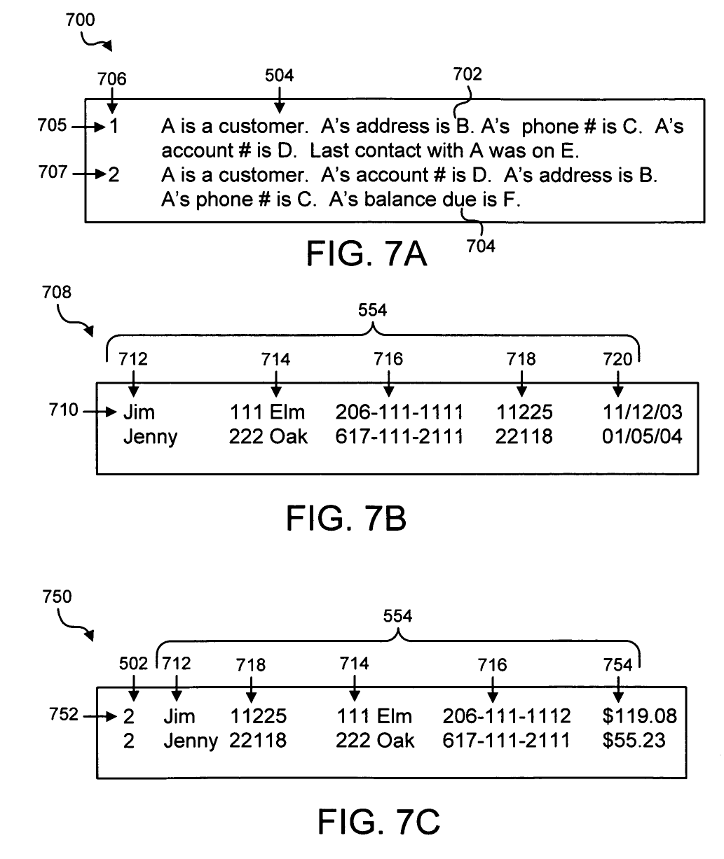

FIG. 7A illustrates an association table 700 that the translation module 606 may use to associate the first predicate 702 with the first database 602 and the second predicate 704 with the second database 604. The association table 700 associates both the first predicate 702 and the second predicate 704 with a database identifier 706. A first database identifier 705 identifies the first database 602 and a second database identifier 707 identifies the second database 604. The first predicate 702 and the second predicate 704 may be compound predicates.

The association module 608 preferably stores the association table 700 since a conventional database, such as the first database 602 or second database 604, may not explicitly store the predicate on which tuples 552 in the database are based. The association module 608 may store the association table 700 in a database, a set of variables, a set of objects, a linked list, or other non-volatile data structure. In one embodiment, the association module 608 stores a first association between the first predicate 702 and a first predicate identifier and a second association between a second predicate 704 and a second predicate identifier.

Returning now to FIG. 6, the query module 408 may retrieve the first tuple from the first database 602 based on a query expression in substantially the same manner as described above in relation to FIG. 4. A database administrator may retrieve substantially all of the tuples 552 from one or more tables of the first database 602 by creating a query expression satisfied by substantially all of the tuples 552 in one or more tables of the first database 602. The query module 408 provides the retrieved first tuple to the mapping module 612. The mapping module 612 maps one or more of the arguments 554 of the first tuple to one or more of the arguments 554 of a second tuple in substantially the same manner as described above in relation to the conversion module 412 of FIG. 4.

The system 600 is useful in translating information from one format to another. For example, a business may have a Customer Relationship Management (CRM) database that customer service representatives use to record customer information such as customer name, address, phone number, and the like. A first vendor may provide the CRM database to the business. The business may also have a billing database used to record information such as customer name, account number, balance due, and the like. A second vendor may provide the billing database to the business.

Most of the data stored by the CRM database, such as the customer name, address, phone number, and account number, will also be in the billing database. Since two different vendors provide the CRM database and billing databases, the two databases will most likely use different tuple formats for storing data. The business may require that common information about customers that is stored in both databases be identical.

For example, the customer name stored in the CRM database and the customer name stored in the billing database should be identical. Additionally, changes made by a customer service representative in the CRM database should be automatically updated in the billing database. Automatically updating the billing database based on changes in the CRM database may be difficult in conventional databases since the two databases use different representations of the data. It may be more cost effective to make the two databases work together than to design and build a customized database that consolidates the customer information. The system 600 may be used to automatically translate tuples stored in a CRM database format to tuples stored in a billing database format.

FIG. 7B illustrates the contents 708 of a sample CRM database 602. A first tuple 710 comprises five arguments: “A” 712, “B” 714, “C” 716, “D” 718, and “E” 720. The five arguments 554 are related through the first compound predicate 702 (See FIG. 7A). The first tuple 710 does not include a predicate identifier 502.

FIG. 7C illustrates the contents 750 of a sample billing database 604. A second tuple 752 comprises five arguments 554: the predicate identifier 502, “A” 712, “D” 718, “B” 714, “C” 716, and “F” 754. The five arguments 554 are related through the second compound predicate 704 (See FIG. 7A). The second compound predicate 704 uses a different order for the arguments 554 than the first compound predicate 702.

For example, billing database may require the “customer account number” argument “D” 718 to be the second argument 554 in the second tuple 752 whereas the CRM database may require the “customer account number” argument “D” 718 to be the fourth argument 554 in the first tuple 710. Additionally, the billing database may require a “balance due” argument “F” 754 that may not be required by the CRM database.

The mapping module 612 maps the matching arguments 554 from the first tuple 710 to the second tuple 752. In this example, the mapping module 612 stores arguments “B” 714, “C” 716, and “D” 718 in different positions within the second tuple 752 than they were located in the first tuple 710. Additionally, the mapping module 612 creates a new argument “F” 754 for the second tuple 752. The new argument “F” 754 may be populated with a database administrator specified default value.

Once the mapping module 612 maps the first tuple 710 to the second tuple 752, the storage module 406 stores the second tuple 752 in the second database 604. Of course, the storage module 406 may store the second tuple 752 without a predicate identifier 502 in a second database 604 that is not capable of storing the predicate identifier 502. In another embodiment, the storage module 406 stores the translated second tuple 752 in a new table of the first database 602 rather than in the second database 604.

In one embodiment, the system 600 may dynamically translate tuples based on a first predicate 702 to tuples based on a second predicate 704 in response to changes in the first database 602. For example, the system 600 may create a new tuple based on the second predicate 704 in response to a customer service representative adding a new tuple based on the first predicate 702 to the first database 602. Similarly, the system 600 may modify a tuple based on the second predicate 704 in response to modifications to a corresponding tuple based on the first predicate 702. Of course the dynamic translation may occur in the opposite direction as well. For example, the system may dynamically translate tuples based on the second predicate 704 to tuples based on a first predicate 702 in response to changes in the second database 604.

Since the system 600 utilizes an explicit first predicate 702 and an explicit second predicate 704, the database administrator may quickly adapt the system 600 to use different predicates without requiring changes to the database software. Unlike the system 600 described above, conventional databases do not store or use explicit predicates. Although custom systems may be developed to translate between conventional databases using different tuple formats (predicates), the custom systems are typically based on hard coded mappings between the columns of a first database table and the columns of a second database table. Consequently, database administrators are not able to dynamically adapt custom systems to predicate changes. Rather, custom systems require software changes to accommodate predicate changes.

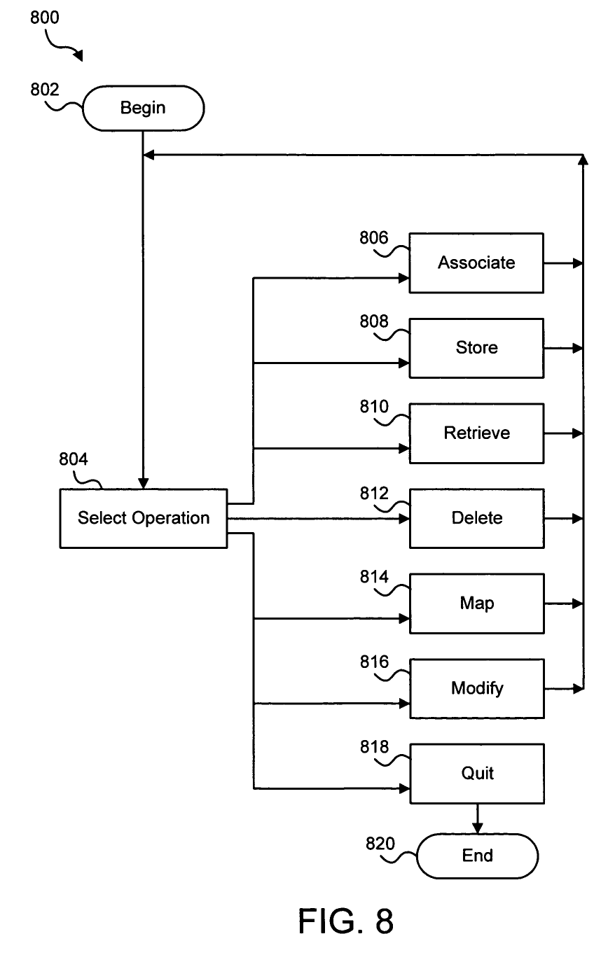

The schematic flow chart diagram included in FIG. 8 is generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 8 illustrates a method 800 for managing objects in a database 402 according to a predicate 504 representative of an explicit relationship between the objects. The method 800 may be embodied as a set of machine-readable instructions. The method 800 begins 802 when a database administrator selects 804 an operation. The database administrator may select an operation to associate, store, retrieve, delete, map, modify, or quit.

If the database administrator selects the operation to associate 806, the correlation module 404 associates a predicate identifier 502 with a predicate 504. Once the operation to associate is complete, the database administrator may select 804 another operation. If the database administrator selects the operation to store 808, the storage module 406 stores a tuple 552 in the database 402. Once the operation to store is complete, the database administrator may select 804 another operation.

If the database administrator selects the operation to retrieve 810, the query module 408 uses a database administrator specified query expression to retrieve a subset of the tuples 552 from the database 402. The query module 408 may also retrieve a predicate 504 based on a predicate identifier 502. The query module 408 may also retrieve a group of predicates 504 associated with a particular argument 552. Once the operation to retrieve is complete, the database administrator may select 804 another operation.

If the database administrator selects the operation to delete 812, the deletion module 410 deletes a selected tuple 552 from the database 402. Once the operation to delete is complete the database administrator may select 804 another operation. If the database administrator selects the operation to map 814, the conversion module 412 maps one or more first tuples based on a first predicate 510 to a plurality of second tuples based on a second predicate 512. Once the operation to map is complete, the database administrator may select 804 another operation.

If the database administrator selects the operation to modify 816, the modification module 414 modifies a selected tuple 552. The modification module 414 may also modify a selected predicate 504. Once the operation to map is complete the database administrator may select 804 another operation. If the operation to quit 818 is selected the method 800 ends 820.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus for managing objects in a database according to a dynamic: predicate representation of an explicit relationship between the objects, the apparatus comprising:
a correlation module configured to associate a set of predicate identifiers with a set of predicates wherein each predicate describes a relationship between objects using a predetermined number of arguments;
a storage module configured to store a set of tuples in a database, each tuple comprising one of the predicate identifiers and the predetermined number of arguments required by the predicate associated with the predicate identifier;
a query module configured to retrieve a subset of the tuples from the database satisfying a query expression; and
a deletion module configured to delete at least one of the tuples from the database.

2. The apparatus of claim 1, wherein the query expression combines arguments for a plurality of predicates.

3. The apparatus of claim 1, further comprising a conversion module configured to map the arguments of a first tuple satisfying a first predicate to a second tuple satisfying a second predicate.

4. A system for translating a first relationship between objects represented by a first predicate to a second relationship between the objects represented by a second predicate, the system comprising:
a first database configured to store a first set of tuples according to a first predicate describing a relationship between objects, each tuple comprising a first predetermined number of arguments;
a second database configured to store a second set of tuples according to a second predicate describing a relationship between objects, each tuple comprising a second predetermined number of arguments;
a translation module including,
a query module configured to retrieve a first tuple from the first database;
a mapping module configured to map the arguments of the first tuple satisfying the first predicate to a second tuple satisfying the second predicate; and
a storage module configured to store the second tuple.

5. The system of claim 4, further comprising an association module configured to associate the first predicate with the first database and the second predicate with the second database.

6. The system of claim 5, wherein the association module is further configured to store a first association between the first predicate and a first predicate identifier and a second association between a second predicate and a second predicate identifier.

7. The system of claim 5, wherein each tuple in the second set of tuples further comprises a predicate identifier.

8. A signal bearing medium tangibly embodying a program of machine-readable instructions executable by a digital processing apparatus to perform operations to manage objects in a database according to a dynamic predicate representation of an explicit relationship between the objects, the operations comprising:
an operation to associate a set of predicate identifiers with a set of predicates wherein each predicate describes a relationship between objects using a predetermined number of arguments;
an operation to store a set of tuples in a database, each tuple comprising one of the predicate identifiers and the predetermined number of arguments required by the predicate associated with the predicate identifier; and
an operation to retrieve a subset of the tuples from the database satisfying a query expression.

9. The signal bearing medium of claim 8, further comprising an operation to delete at least one of the tuples from the database.

10. The signal bearing medium of claim 8, wherein the query expression combines arguments for a plurality of predicates.

11. The signal bearing medium of claim 8, further comprising an operation to map the arguments of a first tuple satisfying a first predicate to a second tuple satisfying a second predicate.

12. The signal bearing medium of claim 8, further comprising an operation to modify one of the predicates.

13. The signal bearing medium of claim 12, further comprising an operation to modify the predetermined number of arguments associated with one of the predicates.

14. The signal bearing medium of claim 8, further comprising an operation to modify the predicate associated with at least one of the tuples.

15. The signal bearing medium of claim 8, further comprising an operation to associate one of the arguments with a plurality of tuples.

16. The signal bearing medium of claim 15, further comprising an operation to retrieve a group of tuples associated with a particular argument.

17. The signal bearing medium of claim 8, further comprising an operation to store the association between the set of predicate identifiers and the set of predicates in the database.

18. The signal bearing medium of claim 17, further comprising an operation to retrieve a predicate associated with a predicate identifier.

19. The signal bearing medium of claim 18, further comprising an operation to retrieve a group of predicates associated with a particular argument.

20. The signal bearing medium of claim 8, further comprising an operation to modify a value for at least one of the arguments associated with at least one of the tuples.
